(19) United States
(12) Patent Application Publication
(10) Pub. No.: US 2021/0055258 A1
(43) Pub. Date: Feb. 25, 2021

(54) HEAT-DISSIPATING APPARATUS OF ELECTROPHORESIS TANK

(71) Applicant: SHANGHAI TANON SCIENCE EQUIPMENT CO., LTD., Shanghai (CN)

(72) Inventor: Chengwei MENG, Shanghai (CN)

(73) Assignee: SHANGHAI TANON SCIENCE EQUIPMENT CO., LTD., Shanghai (CN)

(21) Appl. No.: 17/043,708

(22) PCT Filed: May 23, 2019
(86) PCT No.: PCT/CN2019/088122

§ 371 Date: Sep. 30, 2020

(30) Foreign Application Priority Data
Aug. 13, 2018 (CN) 201821294741.5

(51) Int. Cl. G01N 27/447

(52) U.S. Cl. CPC G01N 27/44708

(57) ABSTRACT

A heat-dissipating apparatus of an electrophoresis tank includes an outer tank and an inner core. The outer tank contains a buffer solution, and the inner core is provided with a rubber plate; a cavity is formed inside the rubber plate, and penetrating heat-dissipating holes are formed on a surface of the rubber plate; and the cavity is enclosed and airtight. The penetrating heat-dissipating holes on the surface of the rubber plate generate liquid convection to promote heat radiation. The heat-dissipating apparatus has a simple structure, a convenient production process and a low cost.

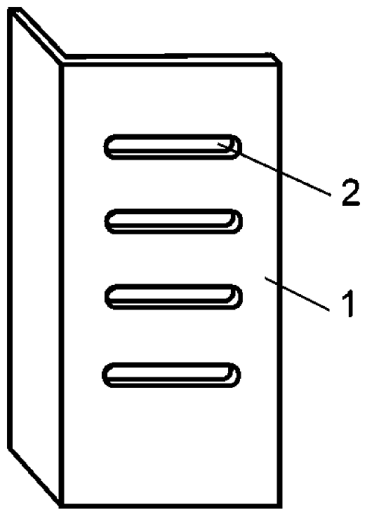

### CROSS REFERENCE TO THE RELATED APPLICATIONS

This application is the national phase entry of International Application No. PCT/CN2019/088122, filed on May 23, 2019, which is based upon and claims priority to Chinese Patent Application No. 201821294741.5, filed on Aug. 13, 2018, the entire contents of which are incorporated herein by reference.

### TECHNICAL FIELD

The present invention relates to an electrophoresis tank, and particularly to a heat-dissipating apparatus of an electrophoresis tank.

### BACKGROUND

Electrophoresis tanks are typically used in biochemical experiments to separate protein molecules of different sizes in a mixture by polyacrylamide gel network due to steric hindrance mechanism.

During operation, a polyacrylamide gel plate is fixed on an electrode stand of the vertical electrophoresis tank to form an inner cavity that is sealed both from inside and outside. Subsequently, an electrophoresis buffer is added to till the inner cavity that is sealed from inside and outside of the electrode stand, a specific electrophoresis buffer is added to the top of an anodic platinum electrode in an outer tank to form a current loop that electrically connects the anodic electrode in the outer tank, the polyacrylamide gel, the cathodic platinum electrode in the inner cavity of the electrode stand and the DC (an abbreviation of direct current) power supply. After adding a mixed protein sample, the DC power supply is turned on. Proteins of different molecular sizes, which act as anions, move towards the anode in the polyacrylamide gel and are eventually separated. However, after the power supply is turned on, the circuit in the electrophoresis tank overheats and sometimes has an uneven temperature, which all cause errors in the experimental results and affect the normal use.

Currently known solutions for the above-mentioned overheating problem that is faced by various vertical electrophoresis tank products on the market include adding air cooling or providing additional liquid cooling devices thereon.

Among them, the liquid cooling manners include, for example, Chinese patent No. 2016213217976 discloses a quick cooling electrophoresis apparatus, which includes a microchannel heat-dissipating plate, and the microchannel in the microchannel heat-dissipating, plate is connected to a water supply pipe with a high cooling speed and a simple structure. A large amount of heat generated in the electrophoresis tank can be dissipated relying on the rapid heat-dissipating function of the microchannel heat-dissipating plate.

Moreover, Chinese patent No. 20172139777336 discloses a polyacrylamide vertical electrophoresis tank. The upper portion of the electrophoresis inner core is provided with a horizontal plate, and the horizontal plate is fixed with a heat-dissipating pipe; the water inlet of the heat-dissipating pipe is in fluid communication to a water pipe, and the water outlet is in fluid communication to a water tank; and the cover of the electrophoresis tank is formed with through holes adapted to the water inlet and the water outlet, which can prevent the samples from decomposing and affecting the electrophoresis effect due to excessively high electrophoresis temperature.

In addition, the air cooling solutions include, for example, a refrigeration and heat radiation device for a biological electrophoresis apparatus, which is disclosed in Chinese patent No. 201210232782.2. The cold end of the thermoelectric module is connected to a working panel of a rubber strip; a heat-dissipating device is provided in the shell and connected to the upper cover, and is adjacent to the hot end of the thermoelectric module; a temperature sensor is provided on the working panel of the rubber strip for sensing the temperature of the working panel, and a temperature sensor is provided on the heat-dissipating device for sensing the temperature of the heat-dissipating device, which realizes the uniform control of the temperature of the rubber strip working panel with a high control accuracy.

There are other solutions such as providing ice cubes as disclosed in Chinese patent No. 201520599057.8 and Chinese patent No. 201620674355.3. Although such solutions can solve the overheating problem to some extent, these solution all require additional equipment, which increases the usage cost and complicates the structure. Therefore, it is necessary to further develop a heat-dissipating apparatus of the electrophoresis tank.

### SUMMARY

The present invention provides a heat-dissipating apparatus of an electrophoresis tank, Which aims to solve the existing problems.

In order to achieve the above objective, the technical solution adopted by the present invention is as follows. The heat-dissipating apparatus includes an outer tank and an inner core, wherein the outer tank contains a buffer solution therein, and the inner core is internally provided with a rubber plate; the rubber plate is internally provided with a cavity, and a surface of the rubber plate is provided with penetrating heat-dissipating holes; and the cavity is enclosed and airtight.

Further, the penetrating heat-dissipating holes each have an elongated shape.

Further, the elongated penetrating heat-dissipating holes are arranged horizontally on the rubber plate.

Compared with the prior art, the present invention breaks the conventional design: penetrating heat-dissipating holes are provided on the surface of the rubber plate, so that liquid convection is generated and heat radiation is promoted; the temperature is effectively reduced and the deviation of the experimental results is avoided without adding additional equipment; and the structure is simple, the production is convenient and the cost is low.

### BRIEF DESCRIPTION OF THE DRAWINGS

FIGURE is a structural schematic diagram of one embodiment of the present invention.

In the drawing: 1. rubber plate, and 2. heat-dissipating hole.

### DETAILED DESCRIPTION OF THE EMBODIMENTS

The present invention is further illustrated below with reference to the drawings.

Referring to the FIGURE, a heat-dissipating apparatus in an embodiment of the present invention includes an outer tank and an inner core, and the outer tank contains a buffer solution therein. The inner core is internally provided with the rubber plate 1, the rubber plate 1 is internally provided with a cavity, and a surface of the rubber plate 1 is provided with a plurality of penetrating heat-dissipating holes 2; and the cavity is enclosed and airtight.

When in use, two rubber plates 1 are paired together, and the two rubber plates 1 are respectively connected to a power supply, and then an electric field is produced in an internal space formed by pairing the two rubber plates, which allows proteins to be separated under the influence of the electric field. The fluid inside and outside the heat-dissipating holes 2 generates convection, which promotes heat radiation and makes the temperature more uniform.

Preferably, four heat-dissipating holes 2 that are in an elongated shape are provided and arranged horizontally and parallel to each other, which is more conducive to processing and liquid convection.

Further, the electric wires generating the electric field can be staggered with the heat-dissipating holes 2, which is more conducive to uniform heat radiation.

The above implementation modes of the present invention are described with reference to the drawings and embodiments. The structures given in the embodiments shall not be construed as limitations to the present invention. Those skilled in the art can make adjustments as required; and various variations or modifications within the scope of the appended claims shall be considered as falling within the protective scope of the present invention.

What is claimed is:

1. A heat-dissipating apparatus of an electrophoresis tank, comprising:
an outer tank; and
an inner core;
wherein the outer tank contains a buffer solution,
wherein the inner core is internally provided with a rubber plate, wherein the rubber plate is internally provided with a cavity, wherein a surface of the rubber plate is provided with a plurality of penetrating heat-dissipating holes; and the cavity is enclosed and airtight.

2. The heat-dissipating, apparatus of the electrophoresis tank according to claim 1, wherein each penetrating heat-dissipating hole of the plurality of penetrating heat-dissipating holes is configured to an elongated shape.

3. The heat-dissipating apparatus of the electrophoresis tank according to claim 2, wherein the each penetrating heat-dissipating hole is arranged horizontally on the rubber plate.
